(19) United States
(12) Patent Application Publication
(10) Pub. No.: US 2015/0287315 A1
(43) Pub. Date: Oct. 8, 2015

(54) MULTI-ITEM LOCATOR

(71) Applicant: Terri Saville-Sewell, Citrus Heights, CA (US)

(72) Inventor: Terri Saville-Sewell, Citrus Heights, CA (US)

(21) Appl. No.: 14/247,777

(22) Filed: Apr. 8, 2014

(51) Int. Cl. G08B 21/24; G08B 3/10

(52) U.S. Cl. CPC G08B 21/24; G08B 3/10

(57) ABSTRACT

A multi-item locator comprising a housing, where the housing includes a front face; a plurality of buttons positioned along the front face of the housing; a plurality of labels positioned below the plurality of buttons, where the plurality of labels each identify one of a plurality of misplaced items; a plurality of adhesive sensors attached to the plurality of misplaced items, where each of the adhesive sensors coordinates to one of the plurality of buttons, where when the button is pressed the coordinating adhesive sensor sounds.

### BACKGROUND OF THE INVENTION

1. Field of the Invention

The present invention relates to a device that utilizes remote sensors to that sound when their coordinating button is pressed on the device to notify the user as to the location of the sensor.

2. Description of Related Art

Hand held technology devices are some of the most convenient and easy-to-use products available to a consumer. Mobile communication devices, like cell phones, smartphones or tablets have been one of the fastest growing and most popular technology devices available on the market. A common problem experienced, is misplacing the mobile communication device, because with the convenience of being handheld and portable, they are small and may be easily lost. It is simple for a person to be talking or using their cell phone one minute, get distracted and put down the phone the next minute. Once they realize they need to use their phone again it is nowhere to be found. The person may take minutes or even hours looking for the phone until they finally call it from another phone or remember where they set it down. This causes frustration and time lost for the user. In the most unfortunate cases, the cellular communication device is permanently lost.

Along with misplacing a mobile communication device, items like keys, remotes, wallets and the like are also easily misplaced items. Most often the items are absentmindedly set down, and then when needed again the user has no recollection of where the item was placed. As such, it would be beneficial in the art to provide an item locator that assists a user to find their misplaced belongings. Additionally, it would be desirable in the art to provide a locator that is able to find different items with a single device.

### SUMMARY OF THE INVENTION

In view of the foregoing disadvantages inherent in the prior art, the general purpose of the present invention is to provide a multi-item locator to locate misplaced items, configured to include all of the advantages of the prior art, and to overcome the drawbacks inherent therein.

Accordingly, an object of the present invention is to provide a device that assists a user to locate their mislaid items.

Another object of the present invention is to provide an item locator that includes sensors attached to the mislaid items, where when a button that coordinates to the sensor is pressed the sensor sounds a noise to inform the user as to the location of the misplaced item.

To achieve the above objects, in an aspect of the present invention, a multi-item locator is described comprising a housing, where the housing includes a front face; a plurality of buttons positioned along the front face of the housing; a plurality of labels positioned below the plurality of buttons, where the plurality of labels each identify one of a plurality of misplaced items; a plurality of adhesive sensors attached to the plurality of misplaced items, where each of the adhesive sensors coordinates to one of the plurality of buttons, where when the button is pressed the coordinating adhesive sensor sounds.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawing in which:

FIG. 1 depicts a perspective view of a multi-item locator in accordance with an exemplary embodiment of the present invention.

### DETAILED DESCRIPTION OF THE DRAWINGS

The present invention relates to a device that utilizes remote sensors to that sound when their coordinating button is pressed on the device to notify the user as to the location of the sensor. The present invention provides a multi-item locator to help users locate their mislaid items. The multi-item locator consists of a control unit that plugs into a wall socket. The control unit includes multiple buttons which coordinate to a sensor attached to a commonly misplaced item. When the user cannot find their misplaced item they simply press the button that matches the sensor to activate the sensor to sound therefore informing the user where their item is. With the multi-item locator the user is afforded peace of mind that they will not waste time and energy looking for their mislaid items.

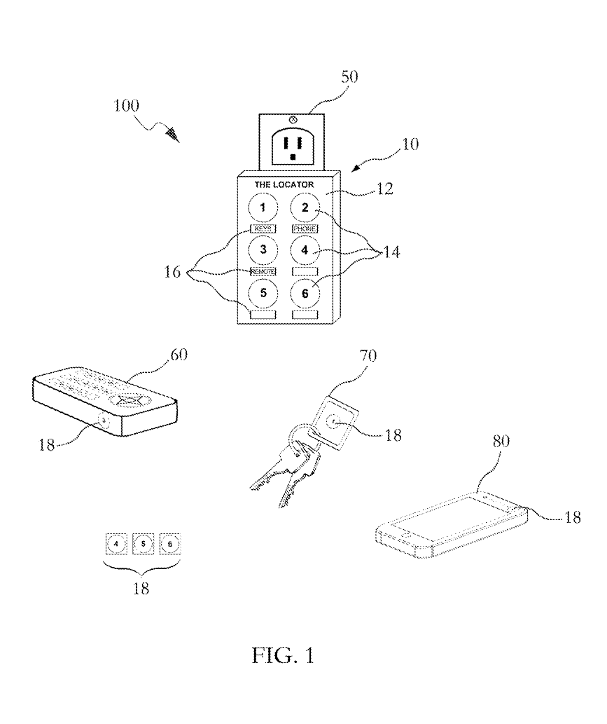

Turning now descriptively to the drawings, referring to FIG. 1, a multi-item locator 100 is shown in accordance with an exemplary embodiment of the present invention. The multi-item locator 100 includes a housing 10 that comprises a generally cuboidal or boxed shape. The housing 10 may plug directly into a wall outlet 50. This way the housing 10 remains in the same place and out of the way for the user. Alternatively, the housing 10 may be battery powered for portability and convenience.

On a front face 12 of the housing 10 are a plurality of buttons 14. The buttons 14 may be numbered and/or colored. Up to 20 buttons 14 may be positioned on the housing 10. Below the buttons 14, a plurality of labels 16 may be positioned on the front face 12 of the housing 10. A plurality of adhesive sensors 18 coordinate in number and/or color to the buttons 14 on the housing 12. The adhesive sensors 18 are attached to a plurality of items 60, 70, 80. The items are any items that the user may routinely misplace, for example a remote 60, a set of keys 70, a cell phone 80, pen, flashlight, passport, wallet, glasses and the like. This list is merely exemplary and not an exhaustive list of all the items to which the sensors may be attached. The labels 16 inform the user as to which item the sensor 18 is attached.

During use, when the user notices that one of their items is missing they simply press the button 14 labeled for their missing item. A signal is then sent from the housing 10 to the sensor 18. The signal activates the sensor 18 to sound therefore notifying the user as to the location of the item. The user needs to simply follow the sound and then their item is found. To stop the sound the user simply presses the button 14 a second time. The sound may be a beep, hum, or continuous note. With the multi-item locator 100 the user is afforded a unique tool able to assist them to easily find their mislaid items.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A multi-item locator comprising:
a. a housing, where the housing includes a front face;
b. a plurality of buttons positioned along the front face of the housing;
c. a plurality of labels positioned below the plurality of buttons, where the plurality of labels each identify one of a plurality of misplaced items;
d. a plurality of adhesive sensors attached to the plurality of misplaced items, where each of the adhesive sensors coordinates to one of the plurality of buttons, where when the button is pressed the coordinating adhesive sensor sounds.

2. The multi-item locator according to claim 1, where the housing is battery powered.

3. The multi-item locator according to claim 1, where the housing plugs into an electrical outlet.

4. The multi-item locator according to claim 1, where the plurality of buttons and the plurality of sensors are numbered with coordinating numbers.

5. The multi-item locator according to claim 1, where the plurality of buttons and the plurality of sensors are colored with coordinating colors.

6. The multi-item locator according to claim 1, where the housing sends a signal to activate the sound from the adhesive sensor when the coordinating button is pressed.

7. A method of use for a multi-item locator comprising the steps of:
a. attaching a sensor to an item;
b. pressing a coordinating button to the sensor when the item is misplaced; and
c. following a sound created by the sensor to locate the item.

8. The method of use for the multi-item locator according to claim 6, further comprising the step of pressing the coordinating button a second time to stop the signal from sounding.
